(19) United States
(12) Patent Application Publication
(10) Pub. No.: US 2026/0264352 A1
(43) Pub. Date: Sep. 10, 2026

(54) LIGNIN-BASED ELECTRICALLY CONDUCTIVE LAYER FOR STRUCTURAL HEALTH MONITORING AND SELF-REPAIR OF BONDED JOINTS

(71) Applicant: The Boeing Company, Arlington, VA (US)

(72) Inventors: Sinan Boztepe, Gdansk (PL); Phillip J. Crothers, Hampton East (AU)

(73) Assignee: The Boeing Company, Arlington, VA (US)

(21) Appl. No.: 19/074,679

(22) Filed: Mar. 10, 2025

(51) Int. Cl. B29C 73/12; B29K 101/12; B29K 105/16; B29K 507/04

(52) U.S. Cl. CPC B29C 73/12; B29K 2101/12; B29K 2105/16; B29K 2507/04; B29K 2995/0005

(57) ABSTRACT

A system for repairing a structural joint includes: a first structural component and a second structural component; a thermoplastic material positioned at a joint interface between the first and second structural components, wherein the thermoplastic material provides structural bonding of the first and second structural components; a layer of lignin-based electrically conductive carbonaceous materials embedded within the thermoplastic material at the joint interface; an electrical measurement system coupled to the layer of lignin-based electrically conductive carbonaceous material and configured to measure an electrical property of the layer for detecting damage to the thermoplastic material; a power system configured to deliver an electrical current to the layer of lignin-based electrically conductive carbonaceous material to locally heat and repair the thermoplastic material at the joint interface.

### FIELD

The present disclosure relates to the integration of lignin-based electrically conductive materials within thermoplastic bonding layers to enable structural health monitoring (SHM) and self-repair of bonded joints. Specifically, it concerns a system and method utilizing a lignin-derived electrically conductive carbonaceous layer embedded in a thermoplastic matrix to detect structural degradation and facilitate in-situ repair through resistive heating. This technology applies to bonded structures across industries such as aerospace, automotive, marine, wind energy, and industrial manufacturing, where ensuring the integrity, reliability, and service life of bonded joints is important to structural performance. The invention further encompasses methods for embedding lignin-based electrically conductive elements within bonding materials to enable continuous or periodic assessment of joint integrity, predictive maintenance, and localized self-repair, whether autonomously or with external intervention. By leveraging variations in electrical properties to detect damage and controlled resistive heating to restore bond strength, this approach provides an efficient, scalable, and sustainable solution for enhancing the durability and operational longevity of bonded assemblies.

### BACKGROUND

Bonded joints are used across industries such as aerospace, automotive, marine, wind energy, and industrial applications due to their ability to distribute loads efficiently while maintaining structural performance. Over time, these joints may be affected by factors such as mechanical loading, fatigue, impact events, environmental exposure, and thermal cycling. These influences can contribute to changes in bond integrity that may require assessment and intervention.

Approaches have been explored to monitor bonded joint integrity and assess degradation by analyzing mechanical, electrical, or thermal properties. Various techniques have been investigated to restore bond performance, including thermal processing methods. Challenges remain in developing solutions that allow for effective monitoring and repair while maintaining compatibility with bonding materials and structural requirements.

### SUMMARY

In one embodiment, the present description relates to a system for repairing a structural joint.

An exemplary system includes a first structural component and a second structural component; a thermoplastic material positioned at a joint interface between the first and second structural components, wherein the thermoplastic material provides structural bonding of the first and second structural components; a layer of lignin-based electrically conductive carbonaceous materials embedded within the thermoplastic material at the joint interface; an electrical measurement system coupled to the layer of lignin-based electrically conductive carbonaceous material and configured to measure an electrical property of the layer for detecting damage to the thermoplastic material; a power system configured to deliver an electrical current to the layer of lignin-based electrically conductive carbonaceous material to locally heat and repair the thermoplastic material at the joint interface.

In another embodiment, the present description relates to a method for repairing a structural joint.

An exemplary method includes: providing a structural joint formed by: i) a first structural component and a second structural component; ii) a thermoplastic material positioned at a joint interface between the first and second structural components, wherein the thermoplastic material provides structural bonding of the first and second structural components; and iii) a layer of lignin-based electrically conductive carbonaceous materials embedded within the thermoplastic material at the joint interface; detecting damage in the thermoplastic material, comprising: i) applying an electrical signal across the layer of lignin-based electrically conductive carbonaceous materials via electrodes; ii) measuring an electrical property of the layer, including at least one of resistance, conductivity, or impedance; and iii) identifying the presence and location of damage based on changes in the measured electrical property; and repairing the identified damage.

Other embodiments of the disclosed systems and method will become apparent from the following detailed description, the accompanying drawings and the appended claims.

### BRIEF DESCRIPTION OF THE DRAWINGS

FIG. 1 illustrates a composite structure with limited access for structural health monitoring and maintenance, highlighting the integration of a lignin-based electrically conductive layer for damage detection and repair.

FIG. 2 is a schematic of a welded thermoplastic joint, showing the damage sensing layer, electrical measurement system, and power system for in-situ monitoring and repair.

FIG. 3 depicts the self-repair process using electrothermal heating and applied pressure, featuring conductive electrodes, a vacuum bagging system, and thermocouples for controlled repair.

FIG. 4 is a flow diagram of a method for repairing a structural joint according to an example of the present description.

FIG. 5 outlines an aircraft manufacturing and service method, illustrating integration of the monitoring and repair system across production and maintenance stages.

FIG. 6 shows an aircraft with key structural areas where the disclosed system enhances durability, reliability, and maintenance efficiency.

### DETAILED DESCRIPTION

The disclosed system and method integrate a lignin-based electrically conductive carbonaceous layer within a thermoplastic bonding material to enable structural health monitoring and self-repair of bonded joints. This approach allows for the detection of changes in electrical properties that indicate degradation and facilitates localized repair through resistive heating. By embedding conductive functionality directly within the bonding material, the system provides an adaptable solution for maintaining the integrity and durability of bonded structures.

The bonded joint is formed using a thermoplastic bonding material that incorporates a lignin-based electrically conductive carbonaceous layer. This conductive layer establishes electrical continuity across the bond interface, enabling the assessment of resistance, conductivity, or impedance changes associated with bond degradation. The conductive layer is integrated within or adjacent to the thermoplastic matrix to ensure stable electrical performance while preserving mechanical integrity.

The thermoplastic bonding material can be applied in various forms, including films, coatings, molded interfaces, or interleaved layers, allowing for flexibility in different structural configurations. The lignin-based conductive layer offers advantages in electrical conductivity, sustainability, cost-effectiveness, and compatibility with thermoplastic processing methods. Its morphology and dispersion characteristics are optimized to maintain stable electrical performance while supporting the mechanical properties of the joint.

Structural health monitoring is achieved by applying an electrical signal across the bonded interface and analyzing variations in electrical properties. These variations provide insight into potential damage, such as microcracks, delamination, or interfacial degradation. This capability allows for continuous or periodic assessment of joint integrity without reliance on external inspection equipment or complex sensor networks. The system can operate in wired or wireless configurations, depending on application needs, facilitating integration into diverse structural assemblies.

When damage is detected, the system enables localized repair by activating the conductive layer as a resistive heating element. By applying an electrical current, localized heating is generated, softening the thermoplastic bonding material and promoting polymer chain entanglement and reflow. This restores the bondline without requiring additional adhesives or mechanical fasteners. External pressure application, such as vacuum bagging or mechanical compression, may be used to enhance the repair process by ensuring uniform crack closure and bond restoration. The repair cycle can be repeated as needed throughout the service life of the structure.

This system is adaptable to a wide range of bonded structures across multiple industries, including aerospace, automotive, marine, wind energy, and industrial applications. It can be applied to various joint configurations, such as lap joints, butt joints, T-joints, hat-stiffened panels, honeycomb sandwich panels, rib-spar assemblies, and bonded skin-stringer structures. By integrating monitoring and repair functionalities within the bonding material itself, the system supports improved durability, simplified maintenance, and extended service life for bonded assemblies.

### OVERVIEW OF SYSTEM FOR STRUCTURAL HEALTH MONITORING AND REPAIR OF BONDED JOINTS

The system is designed for bonded joints formed between structural components that require monitoring and repair capabilities to maintain long-term performance. These structural components can be made from various materials, including metals, composites, and polymers, depending on application requirements. The system applies to a range of bonded configurations, such as lap joints, butt joints, T-joints, hat-stiffened panels, honeycomb sandwich panels, rib-spar assemblies, and bonded skin-stringer structures.

The bonded joint incorporates a thermoplastic bonding material that embeds a lignin-based electrically conductive carbonaceous layer. This conductive layer enables structural health monitoring by allowing for the assessment of changes in electrical properties, such as resistance, conductivity, or impedance, that may indicate bond degradation. The conductive layer is integrated within or adjacent to the thermoplastic matrix, ensuring stable electrical performance while preserving mechanical integrity.

The thermoplastic bonding material can be applied in different forms to accommodate diverse structural needs, including as films, coatings, molded interfaces, or interleaved layers. This flexibility allows for adaptation to various manufacturing processes and structural geometries. The system is compatible with large-scale assemblies and complex structures, providing a practical solution for high-performance bonding applications in aerospace, automotive, marine, wind energy, and industrial sectors.

For monitoring, the system includes an electrical measurement network connected to the conductive layer. This network may involve electrodes placed at locations to apply an electrical signal across the bonded joint and measure variations in electrical properties. By tracking these variations, changes in bond integrity can be identified, enabling condition-based assessments of structural performance. The monitoring system can be configured for continuous or periodic operation, allowing integration into predictive maintenance strategies.

When damage is detected, the system facilitates in-situ repair by utilizing the conductive layer as a resistive heating element. By applying an electrical current, localized heating is generated within the bondline, softening the thermoplastic bonding material and allowing it to reflow. This process restores molecular interactions at the damaged interface, effectively re-establishing bond strength. Pressure application methods, such as vacuum bagging or mechanical compression, may be used in conjunction with heating to enhance the repair process.

The system’s design enables it to be integrated into a wide variety of bonded structures, supporting both new manufacturing and retrofit applications. It provides a scalable solution that enhances structural longevity, minimizes downtime, and reduces maintenance complexity for bonded assemblies in demanding operational environments.

### OVERVIEW OF METHOD FOR MANUFACTURING THE ELECTRICALLY CONDUCTIVE BONDED JOINT

The method for manufacturing the electrically conductive bonded joint involves incorporating a lignin-based electrically conductive carbonaceous layer within a thermoplastic bonding material to create a structurally integrated interface with monitoring and self-repair capabilities. The process is adaptable to various fabrication techniques, allowing integration into different bonding applications across multiple industries.

The thermoplastic bonding material, which serves as the adhesive medium, is prepared through methods such as extrusion, solution casting, compression molding, or additive manufacturing to achieve uniform dispersion of the conductive layer. The conductive layer, composed of lignin-derived carbonaceous materials, is incorporated into the thermoplastic matrix through direct blending, surface coating, or interleaving with pre-fabricated conductive films. The formulation and processing parameters are adjusted to maintain stable electrical properties while ensuring compatibility with the mechanical and thermal characteristics of the bonded structure.

Structural components intended for bonding undergo surface preparation to enhance adhesion and interfacial compatibility. This preparation may involve mechanical treatments such as abrasion, chemical priming, plasma activation, or other techniques that promote bonding efficiency. The thermoplastic bonding material containing the conductive layer is then applied to the joint region in a form that suits the specific structural configuration, such as a pre-formed film, spray coating, or an in-situ deposited layer.

During the bonding process, the structural components are assembled under controlled temperature and pressure conditions to achieve a durable joint. Heat and pressure may be applied through compression molding, vacuum-assisted bonding, induction heating, or other thermoplastic welding methods to activate adhesion and ensure integration of the conductive network within the bondline. The process can be adapted to continuous manufacturing systems for high-throughput production or batch processes for specialized applications.

The resulting bonded joint incorporates an embedded conductive network that enables structural health monitoring and repair functionalities without requiring external modifications. The manufacturing method allows for flexibility in material selection, processing conditions, and joint configurations, ensuring broad applicability across aerospace, automotive, marine, wind energy, and industrial applications.

### OVERVIEW OF METHOD FOR STRUCTURAL HEALTH MONITORING

The method for structural health monitoring involves assessing the integrity of a bonded joint by measuring changes in electrical properties within a lignin-based electrically conductive carbonaceous layer embedded in the thermoplastic bonding material. This method enables detection of bond degradation, such as microcracks, delamination, or interfacial weakening, through variations in resistance, conductivity, or impedance.

To implement the monitoring process, an electrical signal is applied across the conductive layer through positioned electrodes. The signal may be direct current (DC) or alternating current (AC), depending on the sensitivity and resolution required for detecting changes in electrical characteristics. Measurements are taken continuously or periodically, with data compared against baseline values established during the initial fabrication or installation of the bonded joint.

Deviations in electrical properties indicate potential structural changes. An increase in resistance, a decrease in conductivity, or variations in impedance can signal localized damage or material degradation. These measurements can be used to identify early-stage failure mechanisms, enabling predictive maintenance and reducing the need for scheduled inspections.

The method supports different monitoring configurations, including wired or wireless data acquisition systems, depending on application constraints. Data may be collected through multiplexed sensing arrays for spatially resolved monitoring or integrated into automated diagnostic systems for real-time analysis. The approach is adaptable to various bonded structures and can be integrated into predictive maintenance frameworks to enhance reliability and service life across aerospace, automotive, marine, wind energy, and industrial applications.

### OVERVIEW OF METHOD FOR REPAIR OF BONDED JOINTS

The method for repairing bonded joints utilizes a lignin-based electrically conductive carbonaceous layer embedded within the thermoplastic bonding material to enable localized heating and restoration of bond integrity. This approach allows for in-situ repair by softening and reflowing the thermoplastic material, eliminating the need for additional adhesives or mechanical fasteners.

The repair process begins with the application of an electrical current to the conductive layer through placed electrodes. This generates resistive heating at the affected area, raising the temperature of the thermoplastic material to a level that enables molecular diffusion and polymer chain entanglement. The extent and duration of heating are controlled based on the material properties and the severity of the damage to ensure effective reflow while preventing thermal degradation.

During heating, external pressure may be applied to facilitate crack closure and ensure uniform bonding. Pressure application methods such as vacuum bagging, mechanical compression, or pneumatic clamping may be used depending on the structural configuration and accessibility of the joint. This step ensures optimal contact between the softened thermoplastic surfaces, promoting the restoration of mechanical integrity.

Once the thermoplastic material has sufficiently softened and reflowed, the electrical current is reduced, allowing the repaired area to cool in a controlled manner. The joint re-solidifies with restored adhesion and structural strength. This repair process can be repeated multiple times over the service life of the bonded joint, making it a durable and cost-effective solution for maintaining bonded assemblies.

The method is adaptable to various bonded joint configurations, including lap joints, butt joints, T-joints, hat-stiffened panels, honeycomb sandwich panels, rib-spar assemblies, and bonded skin-stringer structures. It can be applied across industries such as aerospace, automotive, marine, wind energy, and industrial applications, providing a scalable and efficient solution for extending the operational life of bonded structures.

The system is designed for bonded joints formed between two structural components, which may be composed of a wide range of materials, including metals, composites, polymers, ceramics, or hybrid material systems. These components may serve as primary load-bearing elements, reinforcements, or functional surfaces within an assembly, depending on the mechanical, thermal, or environmental requirements of the structure.

To ensure compatibility with the thermoplastic bonding material, the surfaces of these structural components may undergo surface treatments to enhance adhesion. These treatments can include mechanical abrasion, chemical priming, plasma treatment, or other surface activation methods that improve bonding efficiency. The joint configuration can be tailored to accommodate different structural and functional requirements, with options including lap joints, butt joints, stepped joints, scarf joints, and complex multi-layered or reinforced assemblies.

Structural components may be designed to withstand static, dynamic, or cyclic loading conditions, with joint configurations selected to optimize stress distribution and accommodate thermal expansion or environmental factors. The system is adaptable to various applications, from lightweight aerospace and automotive structures to high-durability marine, wind energy, and industrial bonded assemblies. The integration of electrical conductivity within the bondline allows for monitoring and repair capabilities without altering the fundamental structural design of the components.

### DETAILED DESCRIPTION OF THE SYSTEM FOR SHM AND REPAIR

### First and Second Structural Components

The system is designed for bonded joints formed between two structural components, which may be composed of a wide range of materials, including metals, composites, polymers, ceramics, or hybrid material systems. These components may serve as primary load-bearing elements, reinforcements, or functional surfaces within an assembly, depending on the mechanical, thermal, or environmental requirements of the structure.

To ensure compatibility with the thermoplastic bonding material, the surfaces of these structural components may undergo surface treatments to enhance adhesion. These treatments can include mechanical abrasion, chemical priming, plasma treatment, or other surface activation methods that improve bonding efficiency. The joint configuration can be tailored to accommodate different structural and functional requirements, with options including lap joints, butt joints, stepped joints, scarf joints, and complex multi-layered or reinforced assemblies.

Structural components may be designed to withstand static, dynamic, or cyclic loading conditions, with joint configurations selected to optimize stress distribution and accommodate thermal expansion or environmental factors. The system is adaptable to various applications, from lightweight aerospace and automotive structures to high-durability marine, wind energy, and industrial bonded assemblies. The integration of electrical conductivity within the bondline allows for monitoring and repair capabilities without altering the fundamental structural design of the components.

### Thermoplastic Material

The thermoplastic material serves as the bonding medium within the joint, providing adhesion, mechanical stability, and environmental resilience while enabling self-repair functionality through localized heating and reflow. It is selected based on its compatibility with structural components, processability, and performance under anticipated service conditions.

The thermoplastic material may be semi-crystalline or amorphous, depending on the application requirements. Semi-crystalline thermoplastics, such as polyetheretherketone (PEEK), polyphenylene sulfide (PPS), polyetherketoneketone (PEKK), polyethylene terephthalate (PET), and polyamide (PA), offer high chemical resistance, mechanical strength, and thermal stability. Amorphous thermoplastics, including polycarbonate (PC), polyetherimide (PEI), polymethyl methacrylate (PMMA), and polyphenylsulfone (PPSU), provide excellent impact resistance, dimensional stability, and processability. The thermoplastic matrix may also be modified with additives, fillers, or reinforcement agents to enhance mechanical properties, electrical conductivity, or thermal performance.

The thermoplastic bonding material can be applied in various forms, such as films, coatings, molded interfaces, or interleaved layers, allowing for integration into different structural configurations. Its thermal and rheological properties are selected to facilitate controlled reflow under resistive heating, enabling effective self-repair without compromising the mechanical integrity of the joint. The material can be engineered for permanent, semi-permanent, or reversible bonding, allowing for selective disassembly, recycling, or reusability as needed.

By maintaining broad compatibility with various processing techniques and structural applications, the thermoplastic bonding system provides a versatile and adaptable solution for industries including aerospace, automotive, marine, wind energy, and industrial manufacturing.

### Lignin-Based Electrically Conductive Carbonaceous Layer

The lignin-based electrically conductive carbonaceous layer is embedded within the thermoplastic bonding material to enable both structural health monitoring and self-repair of bonded joints. This layer establishes an electrically conductive network across the bondline, allowing for the detection of changes in electrical properties associated with bond degradation and facilitating localized resistive heating for repair.

The conductive layer is derived from lignin, a naturally occurring biopolymer, which may be processed through carbonization, chemical modification, or structural enhancement techniques to improve its electrical conductivity while maintaining compatibility with thermoplastic matrices. The resulting lignin-based carbonaceous material may include lignin-derived graphene, graphite structures, or other carbon-rich morphologies that enable efficient electron transport and thermal dissipation.

The morphology and dispersion of the conductive material within the thermoplastic matrix may be optimized to ensure consistent electrical performance without compromising mechanical integrity. The conductive layer may include a range of particle or flake sizes to balance electrical percolation, mechanical reinforcement, and thermal stability. Flakes and particulates may be engineered to have an average size ranging from sub-micron to several millimeters, with larger structures contributing to enhanced conductivity and mechanical robustness.

The lignin-based conductive layer can be incorporated into the thermoplastic bonding material through various processing techniques, including direct blending, in-situ polymerization, solution casting, or interleaving with pre-fabricated conductive films. Surface functionalization or alignment strategies may be used to optimize electrical connectivity and durability.

In addition to enabling health monitoring and self-repair, the conductive layer may provide additional functionalities such as electromagnetic shielding, thermal management, or integrated sensing capabilities. The use of lignin-based conductive materials supports sustainability initiatives by utilizing bio-derived resources, offering a scalable and cost-effective alternative to petroleum-based conductive additives.

By integrating electrical conductivity within the bondline, the lignin-based conductive layer enhances the durability, reliability, and self-maintenance capabilities of bonded structures across aerospace, automotive, marine, wind energy, and industrial applications.

### Electrical Measurement System

The electrical measurement system is responsible for monitoring the integrity of the bonded joint by assessing variations in electrical properties within the lignin-based electrically conductive carbonaceous layer. By detecting changes in resistance, conductivity, or impedance, the system enables the identification of potential bond degradation, such as microcracks, delamination, or interfacial weakening.

The system includes at least one pair of electrodes positioned to interface with the conductive layer. These electrodes may be surface-mounted, embedded within the thermoplastic bonding material, or integrated into the structural components to ensure reliable electrical contact. The configuration of the electrodes can be adapted to different joint geometries to enable localized or distributed sensing across bonded interfaces.

A controlled electrical signal, either direct current (DC) or alternating current (AC), is applied across the conductive layer to facilitate measurement. DC measurements provide direct resistance values, while AC-based impedance spectroscopy enables the detection of subtle interfacial changes that may not be apparent through resistance alone. The electrical signal parameters are adjustable to optimize sensitivity and resolution based on the application requirements.

The system includes a detection unit, which may include a resistance meter, impedance analyzer, or other measurement circuitry capable of capturing changes in electrical properties. To improve accuracy, a two-point or four-point probe configuration may be used to minimize the effects of contact resistance and ensure precise readings. The data collected from these measurements can be used to track the progression of structural changes over time.

The electrical measurement system can operate in either a wired or wireless configuration, depending on the application. In a wired setup, the measurement system is directly connected to a monitoring unit for real-time data acquisition. Alternatively, a wireless configuration may utilize radio frequency (RF) communication, near-field communication (NFC), or Bluetooth Low Energy (BLE) to transmit data to remote monitoring stations. This allows for integration into digital maintenance frameworks, predictive diagnostics, and automated alert systems.

To enable spatially resolved monitoring, the system may incorporate multiplexed sensing arrays that distribute electrodes across different regions of the bonded joint. These arrays allow for the precise localization of damage by comparing electrical responses from various areas. Advanced implementations may also use data processing techniques, such as machine learning algorithms or signal pattern recognition, to identify trends and predict potential failures.

By integrating real-time or periodic monitoring capabilities within the bonded joint, the electrical measurement system enhances reliability, reduces the need for manual inspections, and supports predictive maintenance strategies. This approach is applicable across aerospace, automotive, marine, wind energy, and industrial sectors, providing a scalable and efficient solution for ensuring the longevity of bonded structures.

### Power System

The power system provides controlled electrical energy to the lignin-based electrically conductive carbonaceous layer, enabling both structural health monitoring and localized resistive heating for self-repair. It is designed to regulate energy input efficiently, ensuring sufficient power is delivered for damage detection and repair while preventing overheating or material degradation.

The system includes an electrical power source capable of supplying a controlled current or voltage to the conductive layer. The power source may be externally connected, integrated into the bonded structure, or derived from alternative energy sources such as onboard batteries, capacitive energy storage, or energy harvesting technologies. Depending on the application, power delivery can be managed through direct electrical connections, inductive coupling, or other wireless power transfer methods.

To maintain precise control over power distribution, the system incorporates a monitoring unit that detects operational conditions such as electrical resistance fluctuations, temperature at the joint interface, and impedance variations. This allows for dynamic regulation of power input, ensuring that heating remains within the optimal range to facilitate thermoplastic reflow and bond restoration without causing thermal degradation.

The power system can be configured for multiple operating modes:

Automated Mode: The system autonomously activates resistive heating when electrical property variations indicate degradation, applying localized energy as needed to restore the bondline.

User-Initiated Mode: Operators can manually trigger repair cycles based on scheduled maintenance or diagnostic assessments.

Remote-Controlled Mode: The system can be integrated into digital monitoring platforms, allowing remote activation of repair functions based on real-time condition monitoring data.

For safety and efficiency, the power system may include real-time feedback mechanisms such as thermal sensors, voltage regulators, and current limiters. These features help optimize power delivery while preventing overheating or excessive energy consumption. Additionally, advanced implementations may incorporate predictive analytics to adjust power application based on historical performance trends, environmental conditions, and structural load factors.

The power system is adaptable to various bonded joint configurations and operational environments, making it suitable for aerospace, automotive, marine, wind energy, and industrial applications. By enabling precise energy control for monitoring and repair functions, the system enhances the reliability and service life of bonded structures while minimizing maintenance complexity.

### Pressure Application System

The pressure application system plays a role in the self-repair process by ensuring proper closure of cracks and defects within the thermoplastic bonding material while resistive heating facilitates polymer diffusion and reflow. By applying controlled pressure during repair, the system optimizes adhesion, minimizes void formation, and restores mechanical integrity to the bonded joint.

The system can utilize various pressure application methods depending on the structural configuration and accessibility of the joint:

Mechanical Compression: External force may be applied using clamps, hydraulic presses, pneumatic actuators, or robotic-assisted mechanisms to maintain uniform pressure across the repair area.

Vacuum-Assisted Techniques: Negative pressure may be applied through vacuum bagging or sealed enclosures to create uniform compression across large or irregular surfaces, particularly in aerospace and composite applications.

Internally Generated Pressure: Expandable bladders, fluid-driven actuators, or shape-memory alloys embedded within the structure may provide localized pressure without requiring external intervention, allowing for fully integrated self-repair.

The system may include adaptive or real-time control features to regulate the amount and duration of applied pressure based on material behavior, temperature distribution, and bondline condition. Embedded pressure sensors can provide feedback to ensure optimal compaction, preventing excessive deformation or insufficient contact during the repair cycle. In advanced implementations, pressure application may be dynamically adjusted based on environmental conditions, structural loads, or predictive maintenance data.

Depending on the operational environment, the system can be designed for use in extreme conditions, such as high-altitude aerospace structures, underwater marine applications, or high-temperature industrial settings. Pressure delivery components can be selected for compatibility with thermal, chemical, and mechanical stresses to ensure long-term durability and functionality.

By incorporating a controlled pressure application system, the repair process achieves greater effectiveness, reducing the need for manual intervention and improving the reliability of bonded joints. This approach enhances the service life of bonded structures across aerospace, automotive, marine, wind energy, and industrial applications while maintaining structural integrity and performance.

### DETAILED DESCRIPTION OF THE METHOD FOR STRUCTURAL HEALTH MONITORING

Applying an Electrical Signal Across the Layer of Lignin-Based Electrically Conductive Carbonaceous Materials

The method for structural health monitoring involves applying an electrical signal across the lignin-based electrically conductive carbonaceous layer embedded within the thermoplastic bonding material. This conductive layer forms a network that enables the assessment of bond integrity by detecting variations in electrical properties.

An electrical signal, either direct current (DC) or alternating current (AC), is introduced through placed electrodes that interface with the conductive layer. The signal may be applied continuously for real-time monitoring or periodically as part of scheduled assessments. The choice between DC and AC signals depends on the specific sensitivity and resolution required for detecting structural changes.

The electrical excitation is designed to minimize interference and ensure accurate detection of bond degradation. In some configurations, multiplexed or distributed electrode arrays may be used to enable localized monitoring of different regions within a bonded structure. This allows for spatial resolution of damage and a more comprehensive assessment of the joint’s condition.

The method accommodates different operating environments and structural configurations, ensuring compatibility with various monitoring systems. The applied signal parameters—such as voltage level, frequency, and measurement intervals—can be adjusted based on material properties, joint geometry, and environmental factors to optimize detection sensitivity and reliability.

Measuring an Electrical Property of the Layer, Including at Least One of Resistance, Conductivity, or Impedance

Once an electrical signal is applied across the lignin-based electrically conductive carbonaceous layer, the system measures electrical properties to assess the integrity of the bonded joint. These properties include resistance, conductivity, and impedance, each providing insight into potential degradation mechanisms such as microcracks, delamination, or interfacial weakening.

Resistance Measurement: The system detects changes in electrical resistance across the bondline. An increase in resistance may indicate the presence of microcracks, voids, or material degradation that disrupts the conductive network.

Conductivity Measurement: By assessing the material's ability to conduct electrical current, variations in conductivity provide further validation of bond condition. A drop in conductivity suggests reduced contact between conductive pathways due to damage.

Impedance Measurement: Alternating current (AC) impedance analysis is used to detect subtle interfacial changes, including moisture ingress, adhesive degradation, or progressive mechanical wear that may not be captured through simple resistance measurements.

The system may employ a two-point or four-point probe configuration to improve measurement accuracy and minimize contact resistance effects. The selected measurement technique depends on the required sensitivity, joint configuration, and operational constraints.

Measurements can be taken continuously for real-time monitoring or at scheduled intervals for periodic assessment. The collected data is analyzed against baseline values established during fabrication or installation, allowing for early detection of structural changes. Advanced implementations may integrate automated data processing, machine learning algorithms, or signal filtering techniques to enhance detection accuracy and predictive maintenance capabilities.

This approach enables non-intrusive evaluation of bond integrity, supporting efficient maintenance strategies while reducing the need for manual inspections or external diagnostic tools.

Recording Baseline Measurements of the Electrical Property Prior to Operational Use and Comparing Subsequent Measurements to Detect Deviations Indicative of Damage

To establish an effective structural health monitoring system, baseline measurements of electrical properties—such as resistance, conductivity, and impedance—are recorded before the bonded joint enters operational use. These initial measurements serve as a reference point for evaluating future changes in bond integrity.

During the baseline recording phase, electrical properties are measured under controlled conditions, accounting for material composition, bondline thickness, and environmental factors such as temperature and humidity. The system may perform multiple measurements to establish an average baseline value, reducing the impact of transient variations or minor inconsistencies in material properties.

Once operational, subsequent measurements are periodically or continuously recorded and compared against the baseline. Deviations beyond predefined thresholds indicate potential structural degradation.

Resistance Increase: A rise in resistance may signal microcracks, void formation, or a loss of conductive pathways.

Conductivity Drop: A decrease in conductivity suggests material degradation or loss of electrical continuity.

Impedance Shift: Changes in impedance can reveal early-stage damage, moisture infiltration, or interfacial weakening.

To improve accuracy, the system may apply correction factors for environmental variations, such as temperature compensation algorithms or real-time calibration adjustments. Automated data analysis techniques, including pattern recognition and anomaly detection, can further refine damage identification and prediction.

By continuously comparing new data against the baseline, the system enables proactive maintenance, allowing for early intervention before failure occurs. This method enhances the reliability and service life of bonded joints across industries such as aerospace, automotive, marine, wind energy, and industrial applications.

Identifying the Presence and Location of Damage Based on Changes in the Measured Electrical Property

Structural damage within the bonded joint is identified by analyzing deviations in the measured electrical properties compared to the established baseline. The system detects variations in resistance, conductivity, or impedance that indicate the onset or progression of bond degradation.

Presence of Damage: An increase in resistance, a decrease in conductivity, or a shift in impedance values signals potential damage such as microcracks, delamination, or interfacial weakening. The magnitude and rate of change in these properties help determine the severity of the degradation.

Localization of Damage: To pinpoint the affected area, electrical measurements are taken from multiple points within the conductive layer. By comparing readings from different sections of the joint, the system can identify the specific region experiencing degradation.

The system may use various techniques to enhance damage localization:

Differential Measurement Analysis: Comparing electrical responses from different sections of the bondline to identify localized variations.

Multiplexed Electrode Arrays: Placing multiple electrodes across the joint to create a spatially resolved damage map.

Tomographic Imaging Methods: Using impedance or resistance tomography to reconstruct a damage profile of the bonded interface.

Advanced implementations may incorporate machine learning algorithms to analyze historical data trends, improving the accuracy of damage detection and predicting failure progression. The system can trigger alerts or initiate self-repair mechanisms based on predefined thresholds, reducing the need for manual inspections and preventing further structural deterioration.

By integrating electrical property-based damage identification, this method enhances the efficiency of structural health monitoring, supporting predictive maintenance strategies across aerospace, automotive, marine, wind energy, and industrial applications.

### DETAILED DESCRIPTION OF THE METHOD FOR REPAIR OF BONDED JOINTS

Delivering an Electrical Current to the Layer of Lignin-Based Electrically Conductive Carbonaceous Materials to Generate Localized Heat at the Joint Interface

The repair process begins by applying an electrical current to the lignin-based electrically conductive carbonaceous layer embedded within the thermoplastic bonding material. This conductive layer serves as a resistive heating element, generating localized heat precisely at the joint interface to soften the thermoplastic matrix and enable reflow for self-repair.

An external power source supplies a controlled electrical current through electrodes positioned at locations along the bonded joint. The current is regulated to ensure uniform heating without exceeding the thermal stability limits of the thermoplastic material. The resistive heating effect causes a temperature increase in the damaged region, promoting molecular diffusion and polymer chain entanglement, which restores bond integrity.

The method accommodates different power delivery configurations, depending on the structural application:

Direct Current (DC) or Alternating Current (AC): The choice of DC or AC depends on heating efficiency and the conductive properties of the carbonaceous layer.

Localized or Distributed Heating: The system may target specific damaged areas through segmented electrode arrangements or apply broader heating across a larger bondline region.

Automated or User-Controlled Activation: The electrical current can be automatically triggered based on real-time structural monitoring data or manually initiated as part of scheduled maintenance.

Temperature sensors or feedback control mechanisms may be integrated to monitor heat distribution and adjust power input dynamically. This prevents overheating, ensures uniform temperature application, and optimizes energy efficiency. The applied current is maintained until the thermoplastic material reaches the required softening point for reflow and defect closure.

This method enables rapid, targeted repair without requiring additional adhesives or disassembly, providing a scalable and repeatable approach to maintaining bonded joints across aerospace, automotive, marine, wind energy, and industrial applications.

Applying Pressure to the Joint Interface to Facilitate Closure of Damage-Induced Cracks in the Thermoplastic Material

As the thermoplastic bonding material reaches its softening temperature through resistive heating, controlled pressure is applied to the joint interface to facilitate the closure of microcracks, delamination, or other damage-induced defects. This pressure ensures proper material flow, enhances molecular diffusion, and promotes the reformation of a continuous bondline.

The pressure application method varies depending on the structural configuration, accessibility, and repair environment:

Mechanical Compression: Clamps, hydraulic presses, or pneumatic actuators apply direct force to maintain uniform contact between the softened thermoplastic surfaces.

Vacuum-Assisted Compression: Vacuum bagging techniques generate even pressure distribution over large or irregularly shaped bonded areas, commonly used in aerospace and composite applications.

Internal Pressure Mechanisms: Embedded expandable bladders, shape-memory alloys, or fluid-driven actuators generate localized pressure within the bonded structure without requiring external intervention.

The applied pressure is controlled to prevent excessive deformation while ensuring effective defect closure. Pressure sensors or adaptive control mechanisms may be integrated to optimize force distribution and compensate for material shrinkage or irregularities in joint geometry.

Maintaining proper pressure throughout the heating and cooling phases ensures that the repaired bondline achieves high mechanical integrity, free of voids or weak points. This approach enhances the durability and longevity of the bonded joint while minimizing the need for extensive manual intervention or secondary bonding processes.

The method is adaptable to various bonded joint configurations across industries such as aerospace, automotive, marine, wind energy, and industrial manufacturing, providing a scalable and effective solution for self-repairing thermoplastic bonded structures.

Maintaining the Heat and Pressure for a Predetermined Period to Allow the Thermoplastic Material to Soften, Flow, and Self-Heal at the Joint Interface

Once heat and pressure are applied to the bonded joint, they are maintained for a controlled period to allow the thermoplastic material to reach optimal viscosity, flow into damaged regions, and re-establish molecular entanglement. This controlled reflow process restores the bondline’s structural integrity by eliminating microcracks, voids, or delaminations while ensuring seamless adhesion between the repaired surfaces.

The duration for maintaining heat and pressure is determined based on:

Material Properties: The thermal softening temperature, melt viscosity, and molecular weight of the thermoplastic bonding material.

Damage Severity: The size and distribution of cracks or delaminations that need to be closed.

Structural Constraints: The geometry, thickness, and mechanical requirements of the bonded joint.

To achieve uniform repair, the temperature is held just above the thermoplastic softening point but below the threshold that could compromise structural integrity. Pressure remains consistent to prevent void formation and ensure complete wetting of the repair region.

During this phase, embedded sensors or external monitoring systems may track temperature and pressure conditions in real time, adjusting input parameters as needed for optimal repair effectiveness.

After the predetermined heating and compression period, the joint is gradually cooled while maintaining pressure. This controlled cooling phase allows the thermoplastic material to solidify in a stress-free state, ensuring the restored bond maintains high mechanical performance.

By maintaining precise control over heat and pressure, this method enables repeatable and effective self-repair of bonded joints across aerospace, automotive, marine, wind energy, and industrial applications. This approach minimizes manual intervention, extends the service life of bonded assemblies, and reduces downtime in structural maintenance.

### Lignin-Based Electrically Conductive Carbonaceous Materials

Lignin-based electrically conductive carbonaceous materials form the core of the conductive layer, providing the electrical functionality necessary for structural health monitoring and self-repair in bonded joints. These materials are derived from lignin, a renewable and abundant biopolymer, which is processed through thermal, chemical, and structural modifications to achieve high electrical conductivity. The electrical properties, mechanical stability, and compatibility of these materials with thermoplastic matrices make them a sustainable and efficient alternative to conventional conductive fillers.

### Composition of Lignin-Based Electrically Conductive Carbonaceous Materials

Lignin-based electrically conductive carbonaceous materials include lignin-derived graphite, lignin-derived graphene, and other lignin-derived carbon networks, each of which exhibits distinct structural and electrical properties compared to their non-lignin counterparts. The transformation of lignin into these conductive materials involves a interplay of thermal decomposition, molecular rearrangement, and carbonization processes that inherently influence the microstructure, defect density, and conductivity of the final product. Unlike conventionally synthesized graphite and graphene, which are typically derived from petroleum-based precursors or highly purified synthetic carbon sources, lignin-based materials retain structural features influenced by the irregular, heterogeneous, and branched macromolecular architecture of lignin. These inherent characteristics lead to unique morphological differences, including variations in graphitic domain size, interlayer spacing, functional group distribution, and defect density, all of which impact their electrical and mechanical behavior within thermoplastic bonding systems. As a result, lignin-derived carbonaceous materials exhibit distinct conductivity profiles, processing characteristics, and interfacial interactions that differentiate them from conventional carbon-based additives, reinforcing their unique applicability in structural health monitoring and self-repair applications.

Lignin-derived graphite is obtained through high-temperature graphitization processes, typically exceeding 2000° C, which induce the reorganization of carbon structures into stacked graphitic layers. However, unlike synthetic or naturally occurring graphite, lignin-based graphite retains residual structural features from its biopolymeric origin, such as incomplete graphitization, local disorder within graphitic domains, and the presence of heteroatoms or oxygen-functionalized sites. These differences influence its electrical conductivity, which, while high, is often tunable based on processing conditions, allowing for controlled resistive heating performance within the thermoplastic bonding material. Additionally, the microstructural distinctions in lignin-derived graphite can lead to altered interfacial adhesion properties, which can be advantageous in promoting compatibility with polymeric matrices. Unlike highly crystalline synthetic graphite, lignin-based graphite often features turbostratic disorder, which can improve dispersion within thermoplastics and enhance the mechanical flexibility of the conductive layer. These factors make lignin-derived graphite particularly suitable for applications requiring a balance between conductivity, mechanical reinforcement, and controlled interfacial interactions.

Lignin-derived graphene, formed through catalytic graphitization, thermal exfoliation, or oxidative processes, exhibits a structure distinct from conventional graphene due to the inherent molecular complexity of lignin precursors. Unlike graphene obtained from highly purified graphite sources, lignin-derived graphene often features a higher density of edge defects, irregular layer stacking, and variable sheet sizes that contribute to its unique electrical and mechanical properties. The presence of oxygenated functional groups or residual lignin-derived moieties can facilitate improved dispersion within thermoplastic matrices, enhancing processability while maintaining conductive pathways for structural health monitoring. The degree of exfoliation and lateral size of lignin-derived graphene sheets are influenced by precursor selection and processing conditions, allowing for tunable percolation thresholds within the bonding material. Additionally, the structural variability of lignin-derived graphene allows for tailored modifications, such as heteroatom doping or surface functionalization, to further optimize electrical performance and interfacial adhesion. These features provide lignin-based graphene with a distinct performance profile, setting it apart from traditional graphene materials and reinforcing its suitability for thermoplastic-based self-repair applications.

Beyond lignin-derived graphite and graphene, other lignin-derived carbonaceous materials include amorphous carbon structures, nanostructured carbon hybrids, and partially graphitized lignin carbons, each possessing unique conductivity and mechanical properties distinct from synthetic carbon materials. These alternative lignin-derived materials exhibit tunable electrical and thermal properties that can be optimized for specific bonded joint applications, ensuring compatibility with thermoplastic processing while maintaining sustainability advantages inherent to bio-based carbon sources.

By leveraging the intrinsic structural differences of lignin-derived carbonaceous materials compared to petroleum-based or synthetic alternatives, the disclosed invention provides a distinct approach to integrating conductivity within thermoplastic bonding systems for structural health monitoring and self-repair functionalities. The microstructural variations, controlled graphitization levels, and tailored defect characteristics of lignin-based graphite, graphene, and hybrid carbon materials contribute to their unique electrical performance and processing advantages, reinforcing their differentiation from conventional carbon materials and supporting their applicability across a broad range of bonded joint configurations.

### Morphology of Lignin-Based Electrically Conductive Carbonaceous Materials

The morphology of lignin-based electrically conductive carbonaceous materials plays a role in optimizing electrical conductivity while maintaining mechanical integrity within the thermoplastic bonding layer. The structural characteristics of these materials, including particle shape, aspect ratio, porosity, and surface texture, influence their ability to form effective conductive pathways and integrate seamlessly within the polymer matrix. Lignin-derived carbonaceous materials can be engineered into a variety of morphologies, with flake-like graphitized structures being the primary form due to their ability to facilitate percolative conductivity while preserving processability and structural performance. However, other morphologies, such as nanofibers, nanotubes, and porous carbon networks, provide additional tunability in electrical and mechanical properties, ensuring broad applicability across different bonded joint configurations. The unique microstructure of lignin-derived carbon materials, influenced by the inherent heterogeneity of lignin precursors, contributes to their distinctive morphology compared to conventional synthetic carbon additives, reinforcing their suitability for thermoplastic-based structural health monitoring and self-repair applications.

Flake-shaped lignin-derived graphitized structures represent the dominant morphology within the conductive bonding layer, providing large surface areas and efficient electrical percolation. These flakes, formed through high-temperature graphitization and exfoliation processes, include layered graphitic domains that maintain electrical connectivity while offering good dispersion within the thermoplastic matrix. The flake geometry ensures a high degree of lateral contact between conductive elements, reducing the percolation threshold required to achieve continuous electrical pathways. Additionally, the inherent turbostratic disorder in lignin-derived graphite flakes can enhance flexibility and processability, distinguishing them from highly crystalline synthetic graphite. The aspect ratio and thickness of these flakes can be controlled through processing parameters such as milling, exfoliation, and thermal treatment, allowing for tunable conductivity and mechanical reinforcement properties. The flake morphology is particularly advantageous for resistive heating applications, as the broad, planar structure enables uniform current distribution and consistent heat generation, facilitating efficient self-repair of the bonded joint. Furthermore, these flakes exhibit good interfacial adhesion with thermoplastics due to residual functional groups from the lignin precursor, promoting stable electrical performance over extended service life.

Beyond flake-shaped structures, other lignin-derived carbon morphologies offer additional design flexibility and functional enhancements. Lignin-derived carbon nanofibers and nanotube-like formations, produced through electrospinning, catalytic growth, or controlled pyrolysis, provide high aspect ratios that improve charge transport efficiency and mechanical reinforcement. These nanostructures contribute to the formation of interconnected conductive networks, particularly at low filler loadings, by bridging gaps between larger flake-like particles. Their elongated geometry enhances electrical percolation while minimizing disruptions to the mechanical properties of the thermoplastic bonding layer. Additionally, lignin-derived carbon nanofibers exhibit excellent tensile strength and flexibility, making them suitable for applications where crack resistance and load-bearing capabilities are important.

By leveraging the morphological diversity of lignin-derived carbonaceous materials, the disclosed invention provides a versatile and adaptable approach to integrating conductivity within thermoplastic bonding systems. While flake-shaped graphitic structures remain the primary morphology due to their efficient percolation behavior and structural stability, alternative forms enable tailored performance characteristics to suit specific bonded joint applications. These structural variations, inherent to the lignin-based carbonization process, contribute to the unique properties of the material and its differentiation from conventional synthetic carbon additives, reinforcing its effectiveness in structural health monitoring and self-repair functionalities.

### Size Characteristics

The size characteristics of the lignin-based electrically conductive carbonaceous flakes play a important role in determining the electrical performance, mechanical stability, and dispersion behavior within the thermoplastic bonding layer. The flakes exhibit an average size of at least 1 μm², with scalable variations that extend to at least 10 μm², 100 μm², 1000 μm², 10,000 μm², 100,000 μm², or even at least 1 mm², depending on the specific application requirements and processing conditions. The flake size directly influences the percolation threshold of the conductive network, as larger flakes facilitate lower percolation limits while maintaining mechanical reinforcement. Larger flakes, such as those exceeding 1000 μm², contribute to enhanced electrical continuity by reducing interparticle resistance, while smaller flakes, within the 1–100 μm² range, improve matrix integration and dispersion uniformity.

The morphology and lateral dimensions of the flakes are controlled to balance electrical conductivity and mechanical adaptability within the thermoplastic bonding layer. The selection of an appropriate flake size ensures that the conductive layer maintains stable resistive heating properties for self-repair while preserving the structural integrity of the bonded joint. Larger flakes, particularly those at least 10,000 μm² or greater, provide increased lateral contact, enhancing charge transport efficiency and minimizing the risk of conductive pathway disruption due to mechanical stress. Conversely, flakes in the smaller size range, such as those at least 1 μm², enable finer dispersion, ensuring a more homogenous distribution within the thermoplastic matrix while maintaining efficient conductive performance.

The dispersion strategy is optimized to prevent conductivity loss due to flake agglomeration while preserving processability and adhesion within the thermoplastic bonding layer. By controlling the flake size distribution and ensuring effective integration within the polymer matrix, the conductive layer achieves a stable electrical response over an extended service life. Additionally, the processing conditions, including milling, exfoliation, and thermal treatment, are tailored to maintain the desired flake geometry and aspect ratio, ensuring that the flakes contribute to both electrical and mechanical performance. The tunability of flake size, spanning at least 1 μm² to at least 1 mm², allows for application-specific optimizations, reinforcing the versatility of lignin-derived electrically conductive materials in structural health monitoring and self-repair functionalities.

### Thickness Within the Bondline

The thickness of the lignin-based conductive layer is controlled to balance electrical efficiency with mechanical integrity, ensuring stable performance in structural health monitoring and self-repair applications. The conductive layer typically ranges from at least 1 μm to at least 500 μm, with variations depending on application-specific requirements, processing methods, and bondline configurations. A thinner layer, such as between 1 μm and 50 μm, provides sufficient electrical percolation while minimizing material usage and maintaining mechanical flexibility, making it suitable for lightweight or high-precision bonded joints. A thicker layer, within the range of 50 μm to 500 μm, enhances current-carrying capacity for resistive heating and durability, ensuring effective self-repair capabilities in bonded joints subjected to mechanical stress or environmental fluctuations.

The conductive layer can be integrated through various methods, including direct blending, solution casting, or interfacial deposition, ensuring compatibility with thermoplastic processing while maintaining a stable conductive network. The selected thickness ensures that the conductive pathways remain effective under cyclic loading, thermal cycling, and external environmental conditions, preventing premature degradation or conductivity loss. While the specified range provides an optimized balance between electrical and mechanical performance, the invention is not limited to a specific thickness, allowing for adaptation to different structural configurations and performance requirements across aerospace, automotive, marine, wind energy, and industrial applications.

### Conductivity Mechanisms and Electrical Performance

The electrical conductivity of lignin-derived carbonaceous materials is governed by multiple charge transport mechanisms, primarily electron hopping, percolation through interconnected carbon domains, and, in more ordered structures, band-like conduction along graphitic regions. These mechanisms collectively determine the material’s resistivity, charge mobility, and overall electrical performance within the thermoplastic bonding layer. The extent to which each mechanism contributes to conductivity is influenced by factors such as the degree of graphitization, the alignment and connectivity of conductive structures, the presence of functional groups, and the distribution of structural defects inherent to the lignin-derived carbon network.

The percolation threshold plays a crucial role in electrical performance, as sufficient connectivity between conductive particles or flakes must be established to create continuous pathways for charge transport. In materials with higher graphitic content, conductivity is enhanced through extended π-electron delocalization within sp²-hybridized carbon domains, allowing for efficient electron mobility across the conductive layer. Conversely, in less graphitized or more amorphous lignin-derived carbon structures, electron transport occurs primarily through hopping between localized conductive sites, influenced by defect density, residual heteroatoms, and localized energy states. By adjusting processing conditions such as pyrolysis temperature, catalytic treatment, and post-synthesis modifications, the balance between these mechanisms can be tuned to optimize performance for specific structural health monitoring and self-repair applications.

The tunability of conductivity levels in lignin-derived materials provides precise control over resistive heating performance, enabling efficient and localized thermal activation for self-repair processes. The resistivity of the conductive layer can be tailored through material composition, flake size, thickness, and dispersion strategies within the thermoplastic matrix, allowing for controlled Joule heating without excessive energy loss or unintended thermal degradation. This flexibility ensures that the system can accommodate a range of operational conditions, from low-power continuous monitoring applications to high-power localized heating for damage repair.

The stability of lignin-derived conductive materials under repeated electrical cycling is essential for long-term functionality in bonded joints. The structural integrity of the conductive network must be maintained under mechanical loading, thermal expansion, and environmental exposure to prevent conductivity loss over time. Factors such as interfacial adhesion between the conductive layer and the thermoplastic matrix, resistance to oxidation, and mechanical flexibility contribute to ensuring that the electrical properties remain stable through multiple heating and cooling cycles. By leveraging the inherent material properties of lignin-derived carbon, including its ability to sustain charge transport under dynamic conditions, the system provides a reliable, scalable solution for integrating structural health monitoring and self-repair functionalities into bonded joints across aerospace, automotive, marine, wind energy, and industrial applications.

### DESCRIPTION OF THE FIGURES

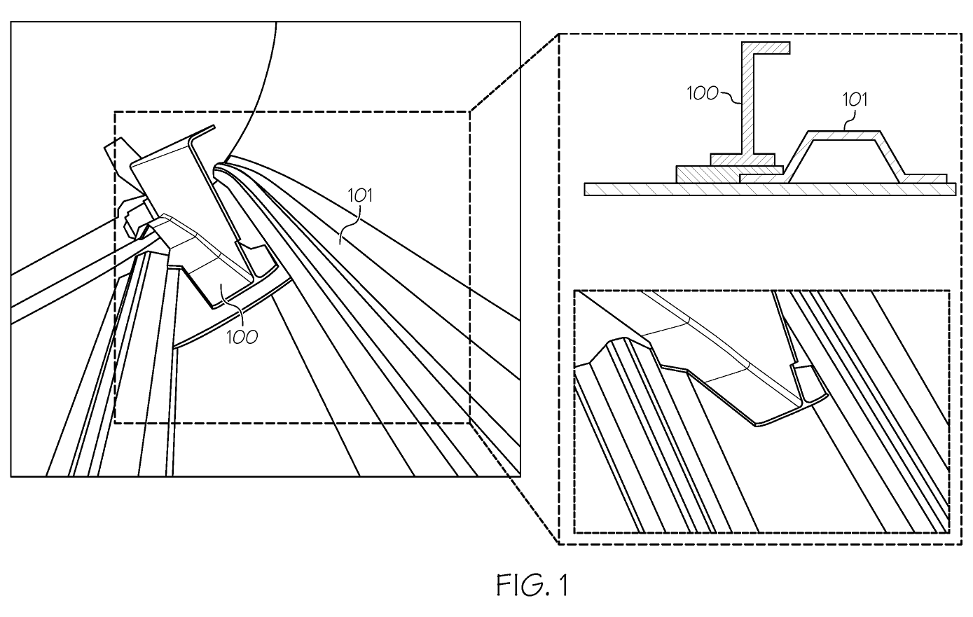

FIG. 1: Assembled Composite Structures with Difficult Accessibility for Structural Health Monitoring and Maintenance

This figure illustrates a section of an aircraft fuselage structure with an assembled first structural component (100) and second structural component (101). The overlapping arrangement of these composite components creates challenges for accessing primary structural elements (PSEs) for maintenance and structural health monitoring (SHM). A red dashed circle highlights a region where accessibility is particularly difficult, emphasizing the necessity for a layer of lignin-based electrically conductive carbonaceous materials within the thermoplastic material. The integration of an electrical measurement system reduces manual inspections and facilitates automated SHM, supporting a power system that enables localized repair through resistive heating.

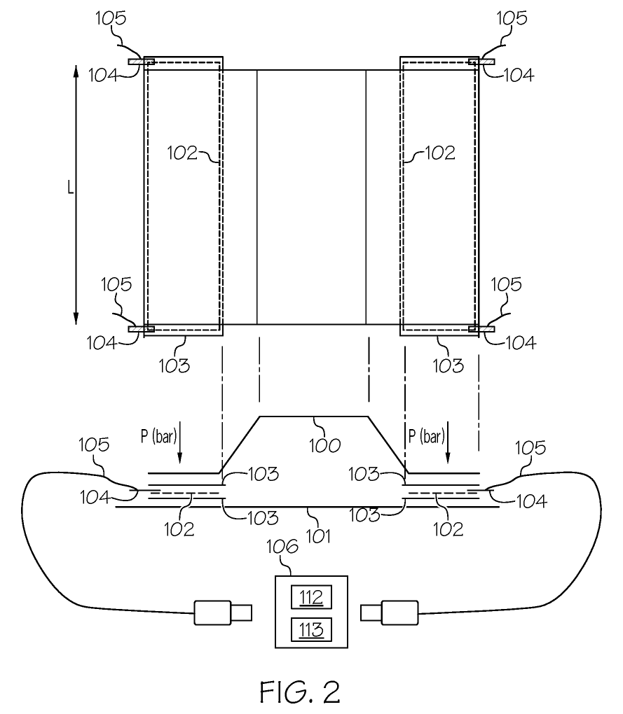

FIG. 2: Schematic Representation of Damage Sensing and In-Situ Structural Health Monitoring of a Welded Thermoplastic Composite Joint

This figure presents a detailed schematic of the proposed lignin-based electrically conductive layer integrated within a welded thermoplastic composite first structural component (100) and second structural component (101). The top view (above) and side view (below) highlight key components:

(100) First structural component – e.g., an omega-shaped airframe stiffener.

(101) Second structural component – e.g., a fuselage skin.

(102) Layer of lignin-based electrically conductive carbonaceous materials – Embedded within the thermoplastic material (103) at the joint interface for damage sensing and self-repair.

(103) Thermoplastic material – Providing structural bonding of the first and second structural components, which may include a first thermoplastic layer and a second thermoplastic layer.

(104) Conductive electrodes – Coupled to the layer (102) for electrical measurement and repair.

(105) Electrical cables/wires – Connecting the electrodes to an external system.

(106) Electrical measurement system – Configured to detect damage through variations in electrical properties such as resistance, conductivity, or impedance.

(107) Plug heads – Allowing interchangeability between SHM and self-repair functionalities.

(112) Voltage or current source – Supplying electrical energy to the layer (102) for SHM.

(113) Resistance detector or impedance analyzer – Measuring electrical properties for detecting damage.

This figure illustrates how the damage sensing elements prevent electrical leakage while enabling real-time condition monitoring. The system detects structural degradation early, allowing for condition-based maintenance without reliance on external inspections.

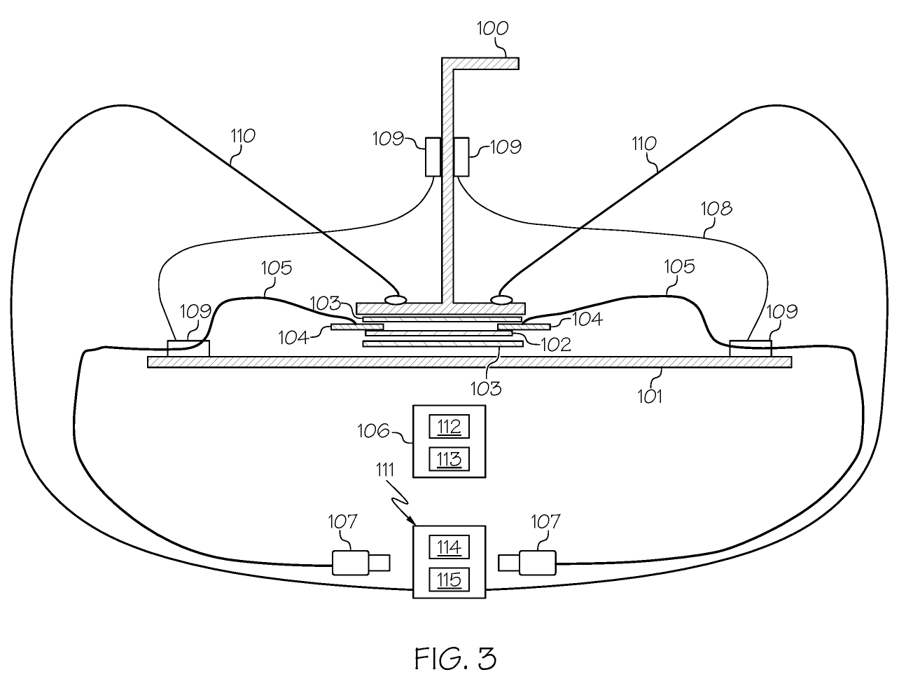

FIG. 3: Self-Repairing of Thermoplastic Structural Joint via Electrothermal Heating Under Pressure

This figure depicts the self-repairing process of a damaged thermoplastic structural joint using the layer (102) of lignin-based electrically conductive carbonaceous materials as a resistive heating element. The key elements include:

(100) First structural component and (101) Second structural component – The thermoplastic composite components forming the bonded joint.

(102) Layer of lignin-based electrically conductive carbonaceous materials – Serving as an electrothermal heater to soften the thermoplastic material (103) for self-healing.

(103) Thermoplastic material – Providing the bonding medium, which may include semi-crystalline or amorphous thermoplastics.

(104) Conductive electrodes – Facilitating controlled current application for resistive heating.

(105) Electrical cables – Transmitting power from an external source to the layer (102).

(106) Electrical measurement system – Monitoring resistance variations for damage detection.

(107) Plug heads – Enabling easy switching between SHM and self-repair functionalities.

(108) Vacuum bagging system – Applying uniform pressure across the repair zone to enhance crack closure.

(109) Tacky tape – Sealing the vacuum bag while allowing electrical cables to pass through without air leakage.

(110) Thermocouples – Monitoring temperature uniformity across the bonded joint to prevent overheating.

(111) Power system – Supplying controlled electrical energy to generate localized heat for repair.

(112) Voltage or current source – Supplying electrical energy to the layer (102) for SHM.

(113) Resistance detector or impedance analyzer – Measuring electrical properties for detecting damage.

(114) Electrical power source – Providing the necessary current for heating the conductive layer.

(115) Monitoring system – Detecting temperature at the joint interface and adjusting power delivery dynamically.

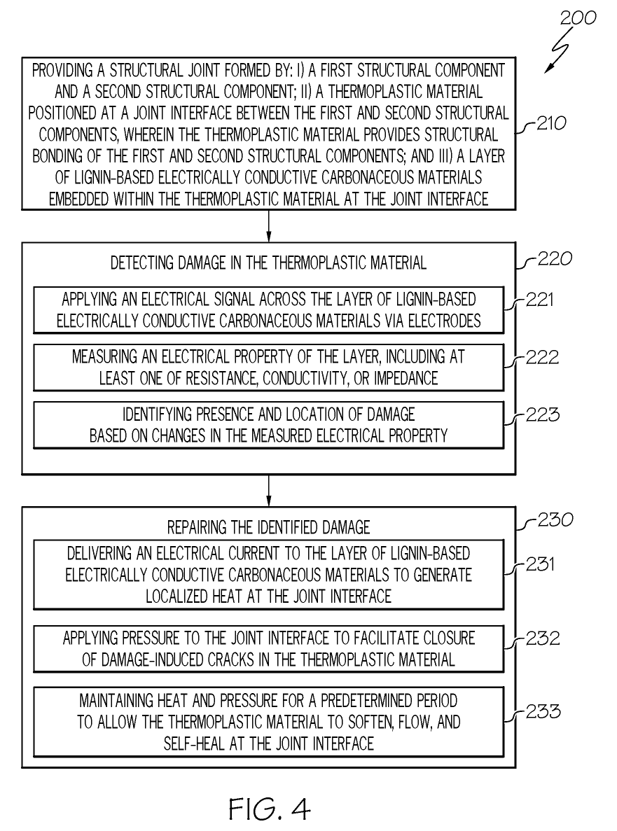

FIG. 4: Flow Diagram of the Method (200) for Structural Joint Repair

FIG. 4 illustrates a flow diagram outlining the method for repairing a structural joint, as described in the present disclosure. The method initiates with the provision of a structural joint, followed by damage detection and repair through an electrically conductive bio-derived layer integrated within the thermoplastic bonding material.

At step (210), a structural joint is formed by joining a first structural component and a second structural component using a thermoplastic material at the joint interface. The thermoplastic material provides structural bonding between the components. A layer of lignin-based electrically conductive carbonaceous materials is embedded within the thermoplastic material at the joint interface to facilitate both structural health monitoring and repair.

At step (220), damage detection is performed by applying an electrical signal across the lignin-based electrically conductive carbonaceous layer using electrodes (221). An electrical property of the conductive layer, including at least one of resistance, conductivity, or impedance, is measured (222). The presence and location of damage are identified based on deviations in the measured electrical properties (223). These deviations indicate potential microcracks, delamination, or interfacial degradation within the thermoplastic bonding layer.

Once damage is detected, repair is initiated at step (230). This process begins with delivering an electrical current (231) to the lignin-based electrically conductive carbonaceous layer, generating localized heat at the joint interface through resistive heating. The generated heat softens the thermoplastic bonding material, enabling molecular diffusion and polymer chain entanglement for self-healing. To enhance the repair process, pressure is applied (232) to the joint interface, facilitating the closure of damage-induced cracks. Heat and pressure are maintained for a predetermined period (233) to allow the thermoplastic material to soften, flow, and restore its structural integrity.

The described method enables in-situ structural repair without requiring disassembly, reducing maintenance time and cost while enhancing the durability and reliability of bonded joints. The flow diagram of FIG. 4 provides a structured representation of the sequential steps undertaken in this damage detection and repair process. This figure illustrates the repair process step-by-step, demonstrating how controlled electrical heating combined with vacuum-assisted pressure application enables polymer chain diffusion and crack closure in thermoplastic joints.

### Additional Considerations

The proposed system and method introduce a cost-effective and sustainable approach to structural health monitoring (SHM) and self-repair of thermoplastic composite joints. One key consideration in implementing this technology is the selection and compatibility of materials. The layer of lignin-based electrically conductive carbonaceous materials should be tailored to balance electrical conductivity, mechanical reinforcement, and thermal stability, ensuring optimal performance for both damage sensing and electrothermal repair. Similarly, the thermoplastic material may be selected to ensure compatibility with the structural components, maintaining structural integrity while facilitating efficient self-repair through localized heating. The electrode materials may also be optimized to provide long-term durability and reliable conductivity under operational conditions.

From a manufacturing perspective, integrating lignin-based conductive materials into thermoplastic joints may involve deposition techniques, including film formation, coating, or interleaving within the thermoplastic matrix. The power system may be configured to prevent overheating or degradation of the thermoplastic material, incorporating real-time monitoring through the electrical measurement system to adjust power delivery dynamically. The use of vacuum bagging during repair processes may facilitate uniform pressure application, enhancing the effectiveness of self-healing in thermoplastic joints.

Beyond technical implementation, the proposed invention provides advantages in reducing costs associated with using bio-derived lignin-based nanomaterials, which may be more affordable and sustainable than fossil-based alternatives. Additionally, the ability to detect and repair damage in composite structures without requiring extensive disassembly may reduce downtime and maintenance costs. The invention may further align with sustainability initiatives by lowering carbon footprint through reduced material waste and energy-efficient maintenance processes.

The ability to implement condition-based maintenance, rather than traditional time-based inspections, may improve structural reliability and service efficiency while reducing operational costs. The use of lignin-based graphene or graphite in multifunctional structural joints may provide enhanced damage sensing and self-repair capabilities, extending the lifespan of composite structures and improving their performance under operational conditions.

This technology offers a novel and scalable approach to enhancing the reliability and maintainability of thermoplastic composite structures, with advantages in cost, performance, and sustainability. Its integration into next-generation composite structures may contribute to greater efficiency, reduced maintenance overhead, and improved structural integrity.

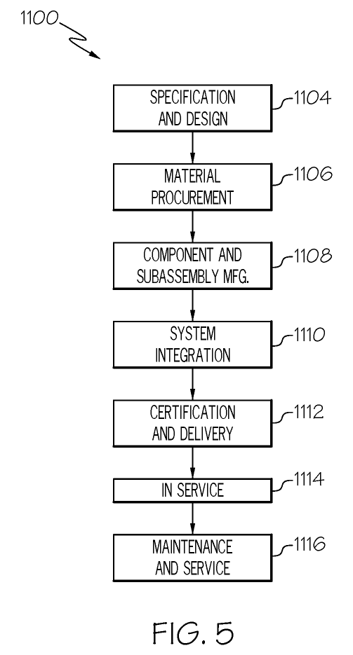

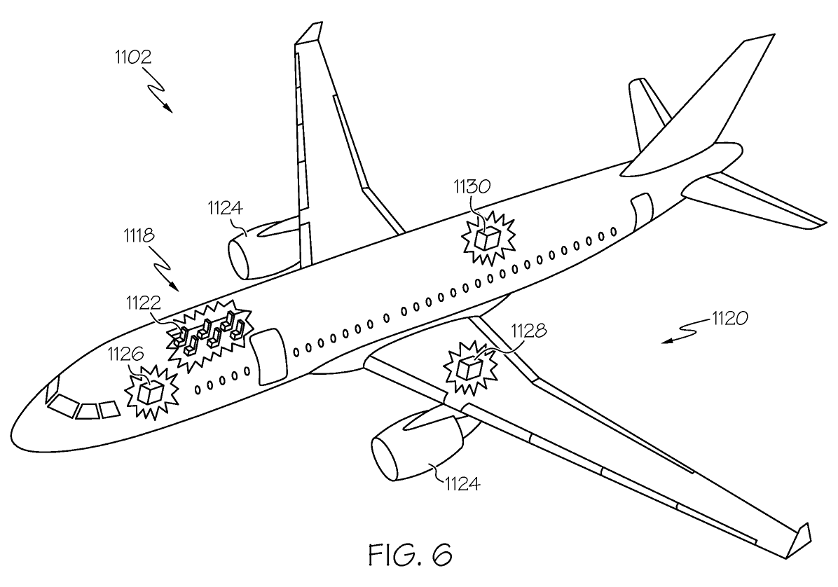

Examples of the subject matter disclosed herein may be described in the context of aircraft manufacturing and service method 1100 as shown in FIG. 5 and aircraft 1102 as shown in FIG. 6. During pre-production, illustrative method 1100 may include specification and design (block 1104) of aircraft 1102 and material procurement (block 1106). During production, component and subassembly manufacturing (block 1108) and system integration (block 1110) of aircraft 1102 may take place. Thereafter, aircraft 1102 may go through certification and delivery (block 1112) to be placed in service (block 1114). While in service, aircraft 1102 may be scheduled for routine maintenance and service (block 1116). Routine maintenance and service may include modification, reconfiguration, refurbishment, etc. of one or more systems of aircraft 1102.

Each of the processes of illustrative method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 6, aircraft 1102 produced by illustrative method 1100 may include airframe 1118 with a plurality of high-level systems 1120 and interior 1122. Examples of high-level systems 1120 include one or more of propulsion system 1124, electrical system 1126, hydraulic system 1128, and environmental system 1130. Any number of other systems may be included. Although an aerospace example is shown, the principles disclosed herein may be applied to other industries, such as the automotive industry. Accordingly, in addition to aircraft 1102, the principles disclosed herein may apply to other vehicles, e.g., land vehicles, marine vehicles, space vehicles, etc.

Apparatus(es) and method(s) shown or described herein may be employed during any one or more of the stages of the manufacturing and service method 1100. For example, components or subassemblies corresponding to component and subassembly manufacturing (block 1108) may be fabricated or manufactured in a manner similar to components or subassemblies produced while aircraft 1102 is in service (block 1114). Also, one or more examples of the apparatus(es), method(s), or combination thereof may be utilized during production stages (block 1108 and block 1110), for example, by substantially expediting assembly of or reducing the cost of aircraft 1102. Similarly, one or more examples of the apparatus or method realizations, or a combination thereof, may be utilized, for example and without limitation, while aircraft 1102 is in service (block 1114) and/or during maintenance and service (block 1116).

### A system for repairing a structural joint is provided.

CLAUSE 1. A system for repairing a structural joint, the system comprising: a first structural component and a second structural component; a thermoplastic material positioned at a joint interface between the first and second structural components, wherein the thermoplastic material provides structural bonding of the first and second structural components; a layer of lignin-based electrically conductive carbonaceous materials embedded within the thermoplastic material at the joint interface; an electrical measurement system coupled to the layer of lignin-based electrically conductive carbonaceous material and configured to measure an electrical property of the layer for detecting damage to the thermoplastic material; and a power system configured to deliver an electrical current to the layer of lignin-based electrically conductive carbonaceous material to locally heat and repair the thermoplastic material at the joint interface.

CLAUSE 2. The system of Clause 1, wherein the thermoplastic material comprises a first thermoplastic layer and a second thermoplastic layer, and wherein the layer of lignin-based electrically conductive carbonaceous materials is positioned between the first and second thermoplastic layers.

CLAUSE 3. The system of Clauses 1 or 2, wherein the thermoplastic material comprises at least one of a semi-crystalline thermoplastic and an amorphous thermoplastic.

CLAUSE 4. The system of Clause 3, wherein the thermoplastic material comprises a semi-crystalline thermoplastic, wherein the semi-crystalline thermoplastic comprises at least one of polyetheretherketone (PEEK), polyphenylene sulfide (PPS), polyimide (PI), polyetherketoneketone (PEKK), polyethylene terephthalate (PET), polypropylene (PP), high-density polyethylene (HDPE), polyamide (PA), and a combination thereof.

CLAUSE 5. The system of Clause 3, wherein the thermoplastic material an amorphous thermoplastic, wherein the amorphous thermoplastic comprises at least one of polycarbonate (PC), polyetherimide (PEI), polymethyl methacrylate (PMMA), polyphenylsulfone (PPSU), acrylonitrile butadiene styrene (ABS), styrene-acrylonitrile (SAN), and a combination thereof.

CLAUSE 6. The system of any one of Clauses 1-5, wherein the layer of lignin-based electrically conductive carbonaceous materials comprises at least one of lignin-based graphene and lignin-based graphite.

CLAUSE 7. The system of any one of Clauses 1-6, wherein the layer of lignin-based electrically conductive carbonaceous materials comprises flakes with an average size of at least 1 μm².

CLAUSE 8. The system of any one of Clauses 1-7, wherein the layer of lignin-based electrically conductive carbonaceous materials comprises flakes with an average size of at least 10 μm².

CLAUSE 9. The system of any one of Clauses 1-8, wherein the layer of lignin-based electrically conductive carbonaceous materials comprises flakes with an average size of at least 100 μm².

CLAUSE 10. The system of any one of Clauses 1-9, wherein the layer of lignin-based electrically conductive carbonaceous materials comprises flakes with an average size of at least 1000 μm².

CLAUSE 11. The system of any one of Clauses 1-10, wherein the layer of lignin-based electrically conductive carbonaceous materials comprises flakes with an average size of at least 10,000 μm².

CLAUSE 12. The system of any one of Clauses 1-11, wherein the layer of lignin-based electrically conductive carbonaceous materials comprises flakes with an average size of at least 100,000 μm².

CLAUSE 13. The system of any one of Clauses 1-12, wherein the layer of lignin-based electrically conductive carbonaceous materials comprises flakes with an average size of at least 1 mm².

CLAUSE 14. The system of any one of Clauses 1-13, wherein the electrical measurement system comprises: at least one pair of electrodes coupled to the layer of lignin-based electrically conductive carbonaceous materials; a voltage or current source configured to apply an electrical signal across the electrodes; and a resistance detector or impedance analyzer configured to measure an electrical property, including at least one of resistance, conductivity, or impedance, for detecting damage to the thermoplastic material.

CLAUSE 15. The system of any one of Clauses 1-14, wherein the power system comprises: an electrical power source configured to deliver electrical energy to the layer of lignin-based electrically conductive carbonaceous materials; and a monitoring system configured to detect one or more operational conditions, including temperature at the joint interface, and to adjust power delivery parameters dynamically to ensure effective repair without overheating or underheating.

CLAUSE 16. The system of any one of Clauses 1-15, further comprising a vacuum bagging system configured to apply uniform pressure during the repair process.

CLAUSE 17. A method for repairing a structural joint comprising: providing a structural joint formed by: (i) a first structural component and a second structural component; (ii) a thermoplastic material positioned at a joint interface between the first and second structural components, wherein the thermoplastic material provides structural bonding of the first and second structural components; and (iii) a layer of lignin-based electrically conductive carbonaceous materials embedded within the thermoplastic material at the joint interface; detecting damage in the thermoplastic material, comprising: (i) applying an electrical signal across the layer of lignin-based electrically conductive carbonaceous materials via electrodes; (ii) measuring an electrical property of the layer, including at least one of resistance, conductivity, or impedance; and (iii) identifying the presence and location of damage based on changes in the measured electrical property; and repairing the identified damage.

CLAUSE 18. The method of Clause 17, wherein the step of repairing the identified damage comprises: (i) delivering an electrical current to the layer of lignin-based electrically conductive carbonaceous materials to generate localized heat at the joint interface; (ii) applying pressure to the joint interface to facilitate closure of damage-induced cracks in the thermoplastic material; and (iii) maintaining the heat and pressure for a predetermined period to allow the thermoplastic material to soften, flow, and self-heal at the joint interface.

CLAUSE 19. The method of any one of Clauses 17-18, wherein the detecting damage step further comprises recording baseline measurements of the electrical property prior to operational use and comparing subsequent measurements to detect deviations indicative of damage.

CLAUSE 20. The method of Clause 18, wherein the pressure applied during the repair process is maintained using a vacuum bagging system configured to provide uniform pressure across the joint interface.

Although various embodiments of the disclosed systems and method have been shown and described, modifications may occur to those skilled in the art upon reading the specification. The present application includes such modifications and is limited only by the scope of the claims.

What is claimed is:

1. A system for repairing a structural joint, the system comprising:
a first structural component and a second structural component;
a thermoplastic material positioned at a joint interface between the first and second structural components, wherein the thermoplastic material provides structural bonding of the first and second structural components;
a layer of lignin-based electrically conductive carbonaceous materials embedded within the thermoplastic material at the joint interface;
an electrical measurement system coupled to the layer of lignin-based electrically conductive carbonaceous material and configured to measure an electrical property of the layer for detecting damage to the thermoplastic material; and
a power system configured to deliver an electrical current to the layer of lignin-based electrically conductive carbonaceous material to locally heat and repair the thermoplastic material at the joint interface.

2. The system of claim 1, wherein the thermoplastic material comprises a first thermoplastic layer and a second thermoplastic layer, and wherein the layer of lignin-based electrically conductive carbonaceous materials is positioned between the first and second thermoplastic layers.

3. The system of claim 1, wherein the thermoplastic material comprises at least one of a semi-crystalline thermoplastic and an amorphous thermoplastics.

4. The system of claim 3, wherein the thermoplastic material comprises a semi-crystalline thermoplastic, wherein the semi-crystalline thermoplastic comprises at least one of polyetheretherketone (PEEK), polyphenylene sulfide (PPS), polyimide (PI), polyetherketoneketone (PEKK), polyethylene terephthalate (PET), polypropylene (PP), high-density polyethylene (HDPE), polyamide (PA), and a combination thereof.

5. The system of claim 3, wherein the thermoplastic material comprises an amorphous thermoplastic, wherein the amorphous thermoplastic comprises at least one of polycarbonate (PC), polyetherimide (PEI), polymethyl methacrylate (PMMA), polyphenylsulfone (PPSU), acrylonitrile butadiene styrene (ABS), styrene-acrylonitrile (SAN), and a combination thereof.

6. The system of claim 1, wherein the layer of lignin-based electrically conductive carbonaceous materials comprises at least one of lignin-based graphene and lignin-based graphite.

7. The system of claim 1, wherein the layer of lignin-based electrically conductive carbonaceous materials comprises flakes with an average size of at least 1 μm².

8. The system of claim 1, wherein the layer of lignin-based electrically conductive carbonaceous materials comprises flakes with an average size of at least 10 μm².

9. The system of claim 1, wherein the layer of lignin-based electrically conductive carbonaceous materials comprises flakes with an average size of at least 100 μm².

10. The system of claim 1, wherein the layer of lignin-based electrically conductive carbonaceous materials comprises flakes with an average size of at least 1000 μm².

11. The system of claim 1, wherein the layer of lignin-based electrically conductive carbonaceous materials comprises flakes with an average size of at least 10,000 μm².

12. The system of claim 1, wherein the layer of lignin-based electrically conductive carbonaceous materials comprises flakes with an average size of at least 100,000 μm².

13. The system of claim 1, wherein the layer of lignin-based electrically conductive carbonaceous materials comprises flakes with an average size of at least 1 mm².

14. The system of claim 1, wherein the electrical measurement system comprises:
at least one pair of electrodes coupled to the layer of lignin-based electrically conductive carbonaceous materials;
a voltage or current source configured to apply an electrical signal across the electrodes; and
a resistance detector or impedance analyzer configured to measure an electrical property, including at least one of resistance, conductivity, or impedance, for detecting damage to the thermoplastic material.

15. The system of claim 1, wherein the power system comprises:
an electrical power source configured to deliver electrical energy to the layer of lignin-based electrically conductive carbonaceous materials; and
a monitoring system configured to detect one or more operational conditions, including temperature at the joint interface, and to adjust power delivery parameters dynamically to ensure effective repair without overheating or underheating.

16. The system of claim 1 further comprising a vacuum bagging system configured to apply uniform pressure during a repair process.

17. A method for repairing a structural joint comprising:
providing a structural joint formed by:
i) a first structural component and a second structural component;
ii) a thermoplastic material positioned at a joint interface between the first and second structural components, wherein the thermoplastic material provides structural bonding of the first and second structural components; and
iii) a layer of lignin-based electrically conductive carbonaceous materials embedded within the thermoplastic material at the joint interface;
detecting damage in the thermoplastic material, comprising:
i) applying an electrical signal across the layer of lignin-based electrically conductive carbonaceous materials via electrodes;
ii) measuring an electrical property of the layer, including at least one of resistance, conductivity, or impedance; and
iii) identifying presence and location of damage based on changes in the measured electrical property; and
repairing the identified damage.

18. The method of claim 17, wherein the step of repairing the identified damage comprises:
i) delivering an electrical current to the layer of lignin-based electrically conductive carbonaceous materials to generate localized heat at the joint interface;
ii) applying pressure to the joint interface to facilitate closure of damage-induced cracks in the thermoplastic material; and
iii) maintaining heat and pressure for a predetermined period to allow the thermoplastic material to soften, flow, and self-heal at the joint interface.

19. The method of claim 17, wherein the detecting damage step further comprises recording baseline measurements of the electrical property prior to operational use and comparing subsequent measurements to detect deviations indicative of damage.

20. The method of claim 18, wherein the pressure applied is maintained using a vacuum bagging system configured to provide uniform pressure across the joint interface.
